(19) United States
(12) Patent Application Publication
(10) Pub. No.: US 2017/0228670 A1
(43) Pub. Date: Aug. 10, 2017

(54) METHOD, APPARATUS, AND SYSTEM FOR GENERATING BUSINESS MODEL, AND COMPUTER READABLE STORAGE MEDIUM

(71) Applicant: Shenzhen Development Promotion Centre for Enterprises, SHENZHEN GUANGDONG (CN)

(72) Inventors: Wei WEI, SHENZHEN GUANGDONG (CN); Wuxiang ZHU, SHENZHEN GUANGDONG (CN)

(73) Assignee: Shenzhen Development Promotion Centre for Enterprises, SHENZHEN GUANGDONG (CN)

(21) Appl. No.: 15/018,202

(22) Filed: Feb. 8, 2016

(51) Int. Cl. G06Q 10/06

(52) U.S. Cl. CPC G06Q 10/067

(57) ABSTRACT

A method, an apparatus, and a system for generating a business model, and a computer readable storage medium are disclosed. The method for generating a business model includes: obtaining stakeholder information, activity information, and resource information in a symbiosis scope; slicing stakeholders, activities, and resources according to the stakeholder information, activity information, and resource information to obtain fine-granularity stakeholders, activities, and resources; and aggregating the sliced stakeholders, activities, and resources into an independent business entity and a platform enterprise according to a boundary of economies of scale and a boundary of economies of scope of the activities and resources, and generating a new business model. The structure of the business model implements harmonious coexistence of links that have different boundaries of economies of scale and different boundaries of economies of scope in one system, and forms a unified, intensive, and efficient company that has a high scale ceiling.

### TECHNICAL FIELD

The present invention relates to the data analysis processing field, and in particular, to a method, an apparatus, and a system for generating a business model, and a computer readable storage medium.

### BACKGROUND

It is considered that a natural scale ceiling exists in many industries, and it is difficult for a company such as a management consulting firm, a law firm, a design company, a farmer, or a stockbreeder to grow larger. All existing business models of these industries generally have the following problems: Operation or implementation processes of the business models are largely affected by professional skills and endeavors of individuals; it is difficult to perform supervision; the scale of personnel having best efficiency is generally small, and the like. The business models of these industries are classified into two types: distributed self-employed individuals or workshops; and loose unilateral platform based cooperatives or partnerships. A pure company based business model is hardly applicable to these industries.

### SUMMARY

Objectives of the present invention are to provide a method, an apparatus, and a system for generating a business model, and a computer readable storage medium.

A method for generating a business model is disclosed, where the method includes the following steps:

obtaining stakeholder information, activity information, and resource information in a symbiosis scope;

slicing stakeholders, activities, and resources according to the stakeholder information, activity information, and resource information to obtain fine-granularity stakeholders, activities, and resources; and

aggregating the sliced stakeholders, activities, and resources into an independent business entity and a platform enterprise according to a boundary of economies of scale and a boundary of economies of scope of the activities and resources, and generating a new business model; where

a transaction is performed between the platform enterprise and the independent business entity, and a transaction interface is relatively standardized; the independent business entity is a link that has an independent factor capacity and a small boundary of economies of scale, or is a combination of multiple links, and the platform enterprise is a combination of businesses that are complementary to the independent business entity and have a large boundary of economies of scale.

An apparatus for generating a business model is disclosed, where the apparatus includes:

an information obtaining unit, configured to obtain stakeholder information, activity information, and resource information in a symbiosis scope;

a slicing unit, configured to slice stakeholders, activities, and resources according to the stakeholder information, activity information, and resource information to obtain fine-granularity stakeholders, activities, and resources; and

an aggregating unit, configured to aggregate the sliced stakeholders, activities, and resources into an independent business entity and a platform enterprise according to a boundary of economies of scale and a boundary of economies of scope of the activities and resources, and generate a new business model; where

a transaction is performed between the platform enterprise and the independent business entity, and a transaction interface is relatively standardized; the independent business entity is a link that has an independent factor capacity and a small boundary of economies of scale, or is a combination of multiple links, and the platform enterprise is a combination of businesses that are complementary to the independent business entity and have a large boundary of economies of scale.

A system for generating a business model is disclosed, where the system includes:

a bus, configured to transmit signaling and data;

a user interface adapter, configured to connect an input device to the bus, and receive stakeholder information, activity information, and resource information in a symbiosis scope that are input by a user;

a display adapter, configured to connect a display device to the bus, display an interface for inputting the stakeholder information, activity information, and resource information, and display a generated new business model; and

a business model generation apparatus, configured to receive the stakeholder information, activity information, and resource information in the symbiosis scope that are transmitted by the user interface adapter through the bus, slice stakeholders, activities, and resources according to the stakeholder information, activity information, and resource information to obtain fine-granularity stakeholders, activities, and resources, aggregate the sliced stakeholders, activities, and resources into an independent business entity and a platform enterprise according to a boundary of economies of scale and a boundary of economies of scope of the activities and resources, and generate a new business model; where

a transaction is performed between the platform enterprise and the independent business entity, and a transaction interface is relatively standardized; the independent business entity is a link that has an independent factor capacity and a small boundary of economies of scale, or is a combination of multiple links, and the platform enterprise is a combination of businesses that are complementary to the independent business entity and have a large boundary of economies of scale.

A computer readable storage medium is disclosed, where the computer readable storage medium stores a computer program instruction executable by a computer, and when the computer executes the computer program instruction, the computer executes a method for generating a business model, where the method for generating a business model includes:

obtaining stakeholder information, activity information, and resource information in a symbiosis scope;

slicing stakeholders, activities, and resources according to the stakeholder information, activity information, and resource information to obtain fine-granularity stakeholders, activities, and resources; and

aggregating the sliced stakeholders, activities, and resources into an independent business entity and a platform enterprise according to a boundary of economies of scale and a boundary of economies of scope of the activities and resources, and generating a new business model; where

a transaction is performed between the platform enterprise and the independent business entity, and a transaction interface is relatively standardized; the independent business entity is a link that has an independent factor capacity and a small boundary of economies of scale, or is a combination of multiple links, and the platform enterprise is a combination of businesses that are complementary to the independent business entity and have a large boundary of economies of scale.

In the method for generating a business model according to the present invention, stakeholder information, activity information, and resource information in a symbiosis scope are obtained; stakeholders, activities, and resources are sliced, so that fine-granularity stakeholders, activities, and resources are obtained; and further, the sliced business activities and resources are aggregated into an independent business entity and a platform enterprise according to boundaries of economies of the business activities and resources. A transaction relationship exists between the platform enterprise and the independent business entity, a transaction interface between the platform enterprise and the independent business entity is relatively standardized, and the aggregation process of the platform enterprise and the independent business entity is performed according to the boundaries of economies of the activities and resources. Therefore, an internal link or a combination of multiple links of the independent business entity has economies of scale, and when the independent business entity includes a combination of multiple links, the combination of multiple links has economies of scope. In addition, a combination of businesses of the platform enterprise has economies of scale, a synergy effect exists between the platform enterprise and the independent business entity, and the combination thereof has economies of scope. In this way, harmonious coexistence of links that have different boundaries of economies of scale and different boundaries of economies of scope is implemented in one system, links of industries that have low scale ceilings are aggregated to form a unified, intensive, and efficient company that has a high scale ceiling, and a problem that business models of existing industries with low scale ceilings are loose and have a low concentration ratio is solved. Because the transaction interface is relatively standardized, the centralized platform enterprise can easily use a consistent transaction procedure for different independent business entities that are decentralized, thereby simplifying the process and improving efficiency.

### BRIEF DESCRIPTION OF DRAWINGS

FIG. 1 is a flowchart of a specific implementation manner of a method for generating a business model according to the present invention;

FIG. 2 is a schematic block diagram of a specific implementation manner of a structure of a business model according to the present invention;

FIG. 3 is a schematic block diagram of a specific implementation manner of an apparatus for generating a business model according to the present invention; and

FIG. 4 is a schematic block diagram of a specific implementation manner of a system for generating a business model according to the present invention.

### DESCRIPTION OF EMBODIMENTS

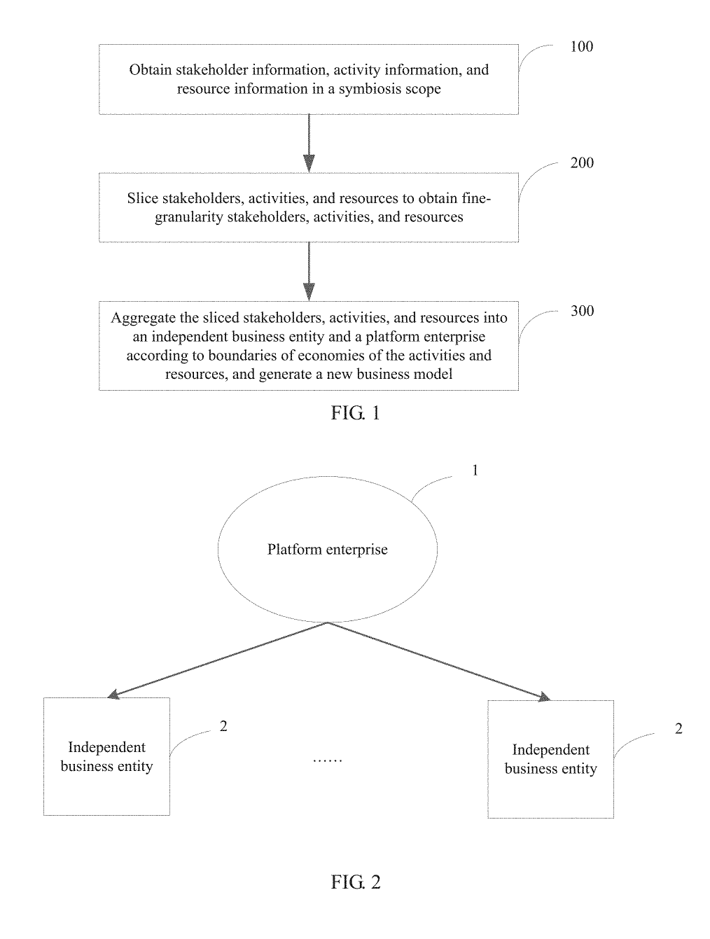

FIG. 1 shows a specific implementation manner of a method for generating a business model according to the present invention. The method includes:

Step 100: Obtain stakeholder information, activity information, and resource information in a symbiosis scope.

In the present invention, a symbiosis is a sum of business models of an enterprise under analysis and business models of stakeholders thereof. Horizontally in an entire activity value chain and vertically in an entire industry value chain, the symbiosis scope refers to (internal and external) stakeholders and activities of the stakeholders that have mutual transactions.

In the present invention, stakeholders are any stakeholders that are affected by a decision or an action of an organization, in internal and external environments of the organization. The stakeholders may be external stakeholders, for example, creditors, suppliers, retailers, and governments, and may be internal stakeholders, for example, employees and shareholders. To define a stakeholder of an organization, it is necessary to determine whether a decision or an action of the stakeholder is affected by the organization. For example, a supplier of an enterprise is apparently a stakeholder of the enterprise, because a decision of the supplier is apparently affected by the enterprise.

In the present invention, the stakeholders in the symbiosis scope may include only the internal and external stakeholders in the existing business models, or may include the internal and external stakeholders in the existing business models and newly introduced stakeholders.

In the present invention, activities refer to specific actions of various stakeholders of an enterprise under analysis. For example, characteristics of production, research and development, sale, logistics, after-sales service, and activities may be specifically described by using attributes of activities.

The attributes of activities are used to specifically describe characteristics of a type of activity. For example, attributes of production refer to activities and processes of creating corporeal properties; attributes of research and development refer to systematic activities with clear goals, which are continuously carried out by various research institutes and enterprises in order to acquire new knowledge of science and technology (not including humanities and social science), creatively apply new knowledge of science and technology, or substantially improve technologies, products, and services.

In the present invention, resources refer to features that are controlled by an enterprise under analysis to implement a strategy of the enterprise under analysis and used to improve operational performance and efficiency of the enterprise under analysis, including all properties, capacities, competitiveness, processes of the enterprise under analysis, features of the enterprise under analysis, data, information, knowledge, and the like. For example, the breeding business activity may be divided into resources such as land, capital, management standards, technologies, labor force, and the like.

Step 200: Slice stakeholders, activities, and resources according to the stakeholder information, activity information, and resource information to obtain fine-granularity stakeholders, activities, and resources.

Any activity involves input of resources, processing of activities, and output. Therefore, it is necessary to decompose resources of stakeholders and slice business activities. For example, it is designed that some business activities may be sliced into sale, solution design, drawing design, publication, and service, and that resources may be sliced into brand, capital, personnel, technology, and cooperative system.

In the present invention, some business activities and resources can be hardly split under an existing technical condition or management level. If those business activities and resources are forcibly split into multiple links, a case of incoherence may occur, which reduces efficiency and greatly increases transaction cost.

In the present invention, the step of slicing stakeholders, activities, and resources according to the stakeholder information, activity information, and resource information to obtain fine-granularity stakeholders, activities, and resources is specifically as follows:

Internal stakeholders of the stakeholders are sliced according to activities and resources owned by the stakeholders, so that fine-granularity stakeholders are obtained.

The activities are sliced according to activity links, so that the activities become smaller activity links and that fine-granularity activities are obtained. Granularities of slicing may vary according to different purposes of slicing.

The resources are further sliced, so that the resources are sliced into finer-granularity resources. For example, original resources of stakeholders are a combination of various resources such as capital and human resources, which are sliced into capital resources and human resources, and granularities of slicing may vary according to different purposes of slicing, for example, increasing transaction value, reducing transaction cost, and reducing risk.

In the present invention, the stakeholders, activities, and resources need to be reconfigured after they are sliced, so that transaction value of a business model is increased. Therefore, during slicing of the stakeholders, activities, and resources, if it is determined that the transaction value of the business model cannot be increased by slicing, slicing is inappropriate, and vice versa.

Step 300: Aggregate the sliced stakeholders, activities, and resources into an independent business entity and a platform enterprise according to a boundary of economies of scale and a boundary of economies of scope of the activities and resources.

A transaction is performed between the platform enterprise and the independent business entity in the new business model, and a transaction interface is relatively standardized; the independent business entity is a link that has an independent factor capacity and a small boundary of economies of scale, or is a combination of multiple links, and the platform enterprise is a combination of businesses that are complementary to the independent business entity and have a large boundary of economies of scale.

Economies of scale mean that if an enterprise increases input of a factor (for example, capital, personnel, and machines), economic effectiveness of the enterprise per unit input of the factor is increased; diseconomies of scale mean that if the enterprise continues to increase the input of the factor, the economic effectiveness of the enterprise per unit input of the factor decreases. Between economies of scale and diseconomies of scale, there is a critical point with highest economic effectiveness per unit input, that is, the input of the factor reaches a boundary of economies of scale.

In the present invention, economies of scale mean that if input of a link is increased, average output per factor input is increased.

In the present invention, a link refers to any one of completely sliced business activities (for example, procurement, production, and sale) and resources (for example, capital, human resources, technologies, and management) or any combination thereof.

In the present invention, economies of scope mean that when a business scope (products and related links) of the enterprise is expanded, economic effectiveness per unit input of a factor (resource or capacity) is increased; conversely, diseconomies of scope mean that if the enterprise continues to expand the business scope, the economic effectiveness per unit input of the factor begins to decrease. Between economies of scope and diseconomies of scope, there is a critical point with highest economic effectiveness per unit input in the business scope, and this critical point is called a boundary of economies of scope.

When economies of scope in the present invention refer to a combination of multiple links, average output per link is increased.

In the present invention, the size of the boundary of economies of scale and the size of the boundary of economies of scope are both based on and constrained by a cornerstone of facilities, a cornerstone of technologies, and a cornerstone of management. After the cornerstone of facilities, the cornerstone of technologies, and the cornerstone of management are improved and enhanced, the boundary of economies of scale and the boundary of economies of scope are expanded correspondingly.

In the present invention, the following rule should be observed in the aggregation process: A stakeholder having a small boundary of economies of scale and being easily copied should become an independent business entity, while a stakeholder having a large boundary of economies of scale should become a platform enterprise.

FIG. 2 shows a structure of the business model generated according to the foregoing method.

The structure of the business model includes a platform enterprise 1 and multiple independent business entities 2, where a transaction is performed between the platform enterprise 1 and the independent business entity 2, and a transaction interface is relatively standardized.

In the present invention, the independent business entity 2 is a link that has an independent factor capacity and a small boundary of economies of scale, or is a combination of multiple links, and when the independent business entity 2 includes a combination of multiple links, the combination of multiple links has economies of scope.

In the present invention, having an independent factor capacity means that the factor capacity can independently play its role, and that input and output can be calculated independently.

In the present invention, the platform enterprise 1 is a combination of businesses that are complementary to the independent business entity 2 and have a large boundary of economies of scale, where the combination of businesses has economies of scale.

Because the platform enterprise 1 provides a combination of resources for the independent business entity 2 to the extent that the platform enterprise 1 provides whatever the independent business entity 2 lacks, a synergy effect exists between the platform enterprise 1 and the independent business entity 2, and the combination thereof has economies of scope.

In the present invention, the transaction interface refers to a transaction mode, a transaction rule, and the like involved in the transaction between the platform enterprise 1 and the independent business entity 2.

To ensure that the structure of the business model in the present invention is more stable and sustainable, in a preferred embodiment of the present invention, the magnitude of the boundary of economies of scale of the platform enterprise 1 is greater than the magnitude of the boundary of economies of scale of the independent business entity 2.

The independent business entity 2 may be a single link, or may include a combination of multiple links. If the independent business entity 2 includes a combination of multiple links, the combination of multiple links has economies of scope, and combined independent business entities 2, as a whole, have economies of scale.

In the method for generating a business model according to the present invention, stakeholder information, activity information, and resource information in a symbiosis scope are obtained; stakeholders, activities, and resources are sliced, so that fine-granularity stakeholders, activities, and resources are obtained; and further, the sliced business activities and resources are aggregated into an independent business entity and a platform enterprise according to boundaries of economies of the business activities and resources. A transaction relationship exists between the platform enterprise and the independent business entity, a transaction interface between the platform enterprise and the independent business entity is relatively standardized, and the aggregation process of the platform enterprise and the independent business entity is performed according to the boundaries of economies of the activities and resources. Therefore, an internal link or a combination of multiple links of the independent business entity has economies of scale, and when the independent business entity includes a combination of multiple links, the combination of multiple links has economies of scope. In addition, a combination of businesses of the platform enterprise has economies of scale, a synergy effect exists between the platform enterprise and the independent business entity, and the combination thereof has economies of scope. In this way, harmonious coexistence of links that have different boundaries of economies of scale and different boundaries of economies of scope is implemented in one system, links of industries that have low scale ceilings are aggregated to form a unified, intensive, and efficient company that has a high scale ceiling, and a problem that business models of existing industries with low scale ceilings are loose and have a low concentration ratio is solved. Because the transaction interface is relatively standardized, the centralized platform enterprise can easily use a consistent transaction procedure for different independent business entities that are decentralized, thereby simplifying the process and improving efficiency.

In addition, in the business model, the platform enterprise 1 has better control over the independent business entities 2, and can better reduce transaction risk.

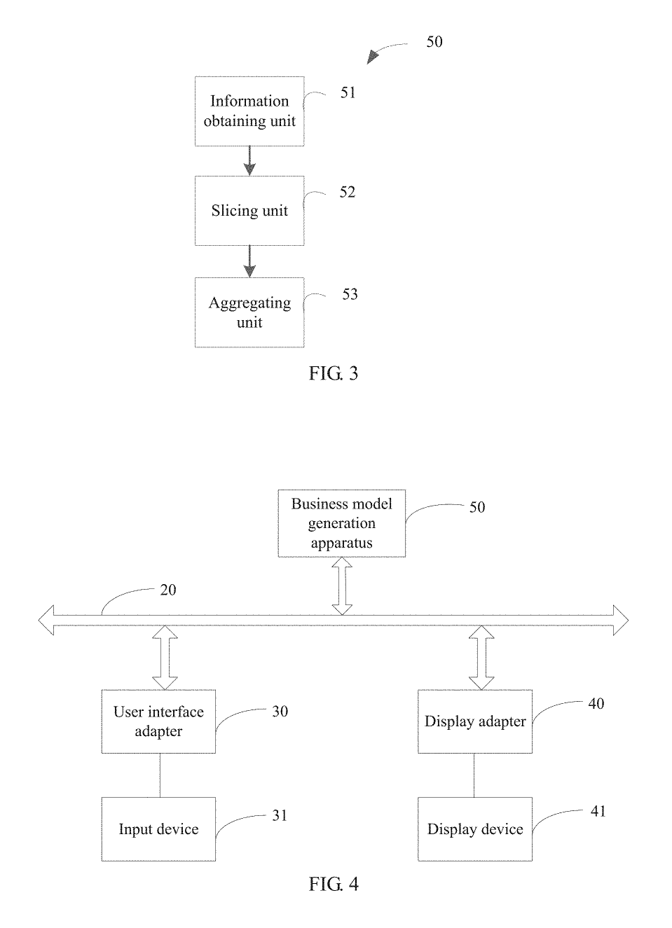

FIG. 3 shows a specific implementation manner of an apparatus 50 for generating a business model according to the present invention. The apparatus 50 includes an information obtaining unit 51, a slicing unit 52, and an aggregating unit 53.

The information obtaining unit 51 is configured to obtain stakeholder information, activity information, and resource information in a symbiosis scope.

In the present invention, a symbiosis is a sum of business models of an enterprise under analysis and business models of stakeholders thereof. Horizontally in an entire activity value chain and vertically in an entire industry value chain, the symbiosis scope refers to (internal and external) stakeholders and activities of the stakeholders that have mutual transactions.

In the present invention, stakeholders are any stakeholders that are affected by a decision or an action of an organization, in internal and external environments of the organization. The stakeholders may be external stakeholders, for example, creditors, suppliers, retailers, and governments, and may be internal stakeholders, for example, employees and shareholders. To define a stakeholder of an organization, it is necessary to determine whether a decision or an action of the stakeholder is affected by the organization. For example, a supplier of an enterprise is apparently a stakeholder of the enterprise, because a decision of the supplier is apparently affected by the enterprise.

In the present invention, the stakeholders in the symbiosis scope may include only the internal and external stakeholders in the existing business models, or may include the internal and external stakeholders in the existing business models and newly introduced stakeholders.

In the present invention, activities refer to specific actions of various stakeholders of an enterprise under analysis. For example, characteristics of production, research and development, sale, logistics, after-sales service, and activities may be specifically described by using attributes of activities.

The attributes of activities are used to specifically describe characteristics of a type of activity. For example, attributes of production refer to activities and processes of creating corporeal properties; attributes of research and development refer to systematic activities with clear goals, which are continuously carried out by various research institutes and enterprises in order to acquire new knowledge of science and technology (not including humanities and social science), creatively apply new knowledge of science and technology, or substantially improve technologies, products, and services.

In the present invention, resources refer to features that are controlled by an enterprise under analysis to implement a strategy of the enterprise under analysis and used to improve operational performance and efficiency of the enterprise under analysis, including all properties, capacities, competitiveness, processes of the enterprise under analysis, features of the enterprise under analysis, data, information, knowledge, and the like. For example, the breeding business activity may be divided into resources such as land, capital, management standards, technologies, labor force, and the like.

The slicing unit 52 is configured to slice stakeholders, activities, and resources according to the stakeholder information, activity information, and resource information to obtain fine-granularity stakeholders, activities, and resources.

Any activity involves input of resources, processing of activities, and output. Therefore, it is necessary to decompose resources of stakeholders and slice business activities. For example, it is designed that some business activities may be sliced into sale, solution design, drawing design, publication, and service, and that resources may be sliced into brand, capital, personnel, technology, and cooperative system.

In the present invention, some business activities and resources can be hardly split under an existing technical condition or management level. If those business activities and resources are forcibly split into multiple links, a case of incoherence may occur, which reduces efficiency and greatly increases transaction cost.

In the present invention, the slicing unit 52 includes:

a stakeholder slicing subunit, configured to slice internal stakeholders of the stakeholders according to the stakeholder information, activity information, and resource information and according to activities and resources owned by the stakeholders, so that fine-granularity stakeholders are obtained;

an activity slicing subunit, configured to slice the activities according to activity links, so that the activities become smaller activity links and that fine-granularity activities are obtained; where, granularities of slicing may vary according to different purposes of slicing; and

a resource slicing subunit, configured to further slice the resources, so that the resources are sliced into finer-granularity resources, where, for example, original resources of stakeholders are a combination of various resources such as capital and human resources, which are sliced into capital resources and human resources, and granularities of slicing may vary according to different purposes of slicing.

In the present invention, the stakeholders, activities, and resources need to be reconfigured after they are sliced, so that transaction value of a business model is increased. Therefore, during slicing of the stakeholders, activities, and resources, if it is determined that the transaction value of the business model cannot be increased by slicing, slicing is inappropriate, and vice versa.

The aggregating unit 53 is configured to aggregate the sliced stakeholders, activities, and resources into an independent business entity and a platform enterprise according to a boundary of economies of scale and a boundary of economies of scope of the activities and resources, and generate a new business model.

In the present invention, a transaction is performed between the platform enterprise and the independent business entity, and a transaction interface is relatively standardized; the independent business entity is a link that has an independent factor capacity and a small boundary of economies of scale, or is a combination of multiple links, and the platform enterprise is a combination of businesses that are complementary to the independent business entity and have a large boundary of economies of scale.

Economies of scale mean that if an enterprise increases input of a factor (for example, capital, personnel, and machines), economic effectiveness of the enterprise per unit input of the factor is increased; diseconomies of scale mean that if the enterprise continues to increase the input of the factor, the economic effectiveness of the enterprise per unit input of the factor decreases. Between economies of scale and diseconomies of scale, there is a critical point with highest economic effectiveness per unit input, that is, the input of the factor reaches a boundary of economies of scale.

In the present invention, economies of scale mean that if input of a link is increased, average output per factor input is increased.

Economies of scope mean that when a business scope (products and related links) of the enterprise is expanded, economic effectiveness per unit input of a factor (resource or capacity) is increased, conversely, diseconomies of scope mean that if the enterprise continues to expand the business scope, the economic effectiveness per unit input of the factor begins to decrease. Between economies of scope and diseconomies of scope, there is a critical point with highest economic effectiveness per unit input in the business scope, and this critical point is called a boundary of economies of scope.

When economies of scope in the present invention refer to a combination of multiple links, average output per link is increased.

In the present invention, the size of the boundary of economies of scale and the size of the boundary of economies of scope are both based on and constrained by a cornerstone of facilities, a cornerstone of technologies, and a cornerstone of management. After the cornerstone of facilities, the cornerstone of technologies, and the cornerstone of management are improved and enhanced, the boundary of economies of scale and the boundary of economies of scope are expanded correspondingly.

The independent business entity may be a single link, or may include a combination of multiple links. If the independent business entity includes a combination of multiple links, the combination of multiple links has economies of scope, and combined independent business entities, as a whole, have economies of scale.

In the present invention, a stakeholder having a small boundary of economies of scale and being easily copied should become an independent business entity, while a stakeholder having a large boundary of economies of scale should become a platform enterprise.

In the apparatus for generating a business model according to the present invention, stakeholder information, activity information, and resource information in a symbiosis scope are obtained; stakeholders, activities, and resources are sliced, so that fine-granularity stakeholders, activities, and resources are obtained; and further, the sliced business activities and resources are aggregated into an independent business entity and a platform enterprise according to boundaries of economies of the business activities and resources. A transaction relationship exists between the platform enterprise and the independent business entity, a transaction interface between the platform enterprise and the independent business entity is relatively standardized, and the aggregation process of the platform enterprise and the independent business entity is performed according to the boundaries of economies of the activities and resources. Therefore, an internal link or a combination of multiple links of the independent business entity has economies of scale, and when the independent business entity includes a combination of multiple links, the combination of multiple links has economies of scope. In addition, a combination of businesses of the platform enterprise has economies of scale, a synergy effect exists between the platform enterprise and the independent business entity, and the combination thereof has economies of scope. In this way, harmonious coexistence of links that have different boundaries of economies of scale and different boundaries of economies of scope is implemented in one system, links of industries that have low scale ceilings are aggregated to form a unified, intensive, and efficient company that has a high scale ceiling, and a problem that business models of existing industries with low scale ceilings are loose and have a low concentration ratio is solved. Because the transaction interface is relatively standardized, the centralized platform enterprise can easily use a consistent transaction procedure for different independent business entities that are decentralized, thereby simplifying the process and improving efficiency.

FIG. 4 shows a specific implementation manner of a system for generating a business model. The system includes:

a bus 20, configured to transmit signaling and data;

a user interface adapter 30, configured to connect an input device 31 to the bus 20, and receive stakeholder information, activity information, and resource information in a symbiosis scope that are input by a user, where the input device includes but is not limited to a keyboard, a mouse, a speaker, a microphone, or the like;

a display adapter 40, configured to connect a display device 41 to the bus 20, display an interface for inputting the stakeholder information, activity information, and resource information, and display a generated new business model, where the display device may be a display, a printer, or an information generation apparatus; and

a business model generation apparatus 50, as described in the specific implementation manner corresponding to FIG. 3, configured to receive the stakeholder information, activity information, and resource information in the symbiosis scope that are transmitted by the user interface adapter 30 through the bus 20, slice stakeholders, activities, and resources according to the stakeholder information, activity information, and resource information to obtain fine-granularity stakeholders, activities, and resources, aggregate the sliced stakeholders, activities, and resources into an independent business entity and a platform enterprise according to boundaries of economies of the activities and resources, generate a new business model, and transmit the new business module to the display adapter 40 through the bus 20.

The business model generation apparatus 50 may be implemented by hardware, or implemented by software, or implemented by a combination of software and hardware.

The apparatus is not described exhaustively herein. For detailed information, reference may be made to the detailed description in the specific implementation manner of the apparatus for generating a business model.

In the system for generating a business model according to the present invention, stakeholder information, activity information, and resource information in a symbiosis scope are obtained; stakeholders, activities, and resources are sliced, so that fine-granularity stakeholders, activities, and resources are obtained; and further, the sliced business activities and resources are aggregated into an independent business entity and a platform enterprise according to boundaries of economies of the business activities and resources. A transaction relationship exists between the platform enterprise and the independent business entity, a transaction interface between the platform enterprise and the independent business entity is relatively standardized, and the aggregation process of the platform enterprise and the independent business entity is performed according to the boundaries of economies of the activities and resources. Therefore, an internal link or a combination of multiple links of the independent business entity has economies of scale, and when the independent business entity includes a combination of multiple links, the combination of multiple links has economies of scope. In addition, a combination of businesses of the platform enterprise has economies of scale, a synergy effect exists between the platform enterprise and the independent business entity, and the combination thereof has economies of scope. In this way, harmonious coexistence of links that have different boundaries of economies of scale and different boundaries of economies of scope is implemented in one system, links of industries that have low scale ceilings are aggregated to form a unified, intensive, and efficient company that has a high scale ceiling, and a problem that business models of existing industries with low scale ceilings are loose and have a low concentration ratio is solved. Because the transaction interface is relatively standardized, the centralized platform enterprise can easily use a consistent transaction procedure for different independent business entities that are decentralized, thereby simplifying the process and improving efficiency.

A person of ordinary skill in the art understands that each aspect of the present invention or a possible implementation manner of each aspect may be specifically implemented as a system, a method, or a computer program product. Therefore, each aspect of the present invention or the possible implementation manner of each aspect may use a form of hardware only embodiments, software only embodiments (including firmware, resident software, and the like), or embodiments with a combination of software and hardware, which are collectively called “a circuit”. “a module”, or “a system”. In addition, each aspect of the present invention or the possible implementation manner of each aspect may use a form of a computer program product, where the computer program product refers to computer readable program code stored in a computer readable medium.

The computer readable medium may be a computer readable signal medium or a computer readable storage medium. A computer readable storage medium includes but is not limited to an electronic, magnetic, optical, electromagnetic, infrared, or semiconductor system, device, or apparatus, or any suitable combination of the foregoing, for example, a random access memory (RAM), a read-only memory (ROM), an erasable programmable read-only memory (EPROM or flash memory), an optical fiber, or a portable compact disc read-only memory (CD-ROM).

A processor in a computer reads the computer readable program code stored in the computer readable medium, so that the processor can execute each step in the flowchart or function actions specified in a combination of steps, and generate an apparatus for implementing each block in a block diagram or function actions specified in a combination of blocks.

The computer readable program code may be completely executed on a computer of a user, or partially executed on a computer of a user, or as an independent software package, partially executed on a computer of a user and partially executed on a remote computer, or completely executed on a remote computer or a server. It should also be noted that in some alternative implementation solutions, each step in the flowchart or the function indicated by each block in the block diagram may occur not in accordance with the sequence indicated in the drawing. For example, two steps or two blocks that are connected and shown depending on involved functions may be actually executed approximately at the same time, or sometimes these blocks may be executed in a reverse sequence.

It is apparent to a person skilled in the art that various modifications and variations can be made to the present invention without departing from the scope or spirit of the present invention. The present invention is intended to cover these modifications and variations provided that they fall within the scope of protection defined by the following claims and their equivalent technologies.

What is claimed is:

1. A method for generating a business model, wherein the method comprises the following steps:
obtaining stakeholder information, activity information, and resource information in a symbiosis scope;
slicing stakeholders, activities, and resources according to the stakeholder information, activity information, and resource information to obtain fine-granularity stakeholders, activities, and resources; and
aggregating the sliced stakeholders, activities, and resources into an independent business entity and a platform enterprise according to a boundary of economies of scale and a boundary of economies of scope of the activities and resources, and generating a new business model; wherein
a transaction is performed between the platform enterprise and the independent business entity, and a transaction interface is relatively standardized; the independent business entity is a link that has an independent factor capacity and a small boundary of economies of scale, or is a combination of multiple links, and the platform enterprise is a combination of businesses that are complementary to the independent business entity and have a large boundary of economies of scale.

2. The method for generating a business model according to claim 1, wherein the boundary of economies of scale is a critical point with highest economic effectiveness per unit input, and the boundary of economies of scope is a critical point with highest economic effectiveness per unit input in a business scope.

3. The method for generating a business model according to claim 1, wherein a magnitude of the boundary of economies of scale of the platform enterprise is greater than a magnitude of the boundary of economies of scale of the independent business entity.

4. An apparatus for generating a business model, wherein the apparatus comprises:
an information obtaining unit, configured to obtain stakeholder information, activity information, and resource information in a symbiosis scope;
a slicing unit, configured to slice stakeholders, activities, and resources according to the stakeholder information, activity information, and resource information to obtain fine-granularity stakeholders, activities, and resources, and
an aggregating unit, configured to aggregate the sliced stakeholders, activities, and resources into an independent business entity and a platform enterprise according to a boundary of economies of scale and a boundary of economies of scope of the activities and resources, and generate a new business model; wherein
a transaction is performed between the platform enterprise and the independent business entity, and a transaction interface is relatively standardized; the independent business entity is a link that has an independent factor capacity and a small boundary of economies of scale, or is a combination of multiple links, and the platform enterprise is a combination of businesses that are complementary to the independent business entity and have a large boundary of economies of scale.

5. The apparatus for generating a business model according to claim 4, wherein the boundary of economies of scale is a critical point with highest economic effectiveness per unit input, and the boundary of economies of scope is a critical point with highest economic effectiveness per unit input in a business scope.

6. The apparatus for generating a business model according to claim 4, wherein a magnitude of the boundary of economies of scale of the platform enterprise is greater than a magnitude of the boundary of economies of scale of the independent business entity.

7. A system for generating a business model, wherein the system comprises:
a bus, configured to transmit signaling and data;
a user interface adapter, configured to connect an input device to the bus, and receive stakeholder information, activity information, and resource information in a symbiosis scope that are input by a user;
a display adapter, configured to connect a display device to the bus, display an interface for inputting the stakeholder information, activity information, and resource information, and display a generated new business model; and
a business model generation apparatus, configured to receive the stakeholder information, activity information, and resource information in the symbiosis scope that are transmitted by the user interface adapter through the bus, slice stakeholders, activities, and resources according to the stakeholder information, activity information, and resource information to obtain fine-granularity stakeholders, activities, and resources, aggregate the sliced stakeholders, activities, and resources into an independent business entity and a platform enterprise according to a boundary of economies of scale and a boundary of economies of scope of the activities and resources, and generate a new business model; wherein
a transaction is performed between the platform enterprise and the independent business entity, and a transaction interface is relatively standardized; the independent business entity is a link that has an independent factor capacity and a small boundary of economies of scale, or is a combination of multiple links, and the platform enterprise is a combination of businesses that are complementary to the independent business entity and have a large boundary of economies of scale.

8. The system for generating a business model according to claim 7, wherein the boundary of economies of scale is a critical point with highest economic effectiveness per unit input, and the boundary of economies of scope is a critical point with highest economic effectiveness per unit input in a business scope.

9. The system for generating a business model according to claim 7, wherein a magnitude of the boundary of economies of scale of the platform enterprise is greater than a magnitude of the boundary of economies of scale of the independent business entity.

10. A computer readable storage medium, wherein the computer readable storage medium stores a computer program instruction executable by a computer, and when the computer executes the computer program instruction, the computer executes a method for generating a business model, wherein the method for generating a business model comprises:
obtaining stakeholder information, activity information, and resource information in a symbiosis scope;
slicing stakeholders, activities, and resources according to the stakeholder information, activity information, and resource information to obtain fine-granularity stakeholders, activities, and resources; and
aggregating the sliced stakeholders, activities, and resources into an independent business entity and a platform enterprise according to a boundary of economies of scale and a boundary of economies of scope of the activities and resources, and generating a new business model; wherein
a transaction is performed between the platform enterprise and the independent business entity, and a transaction interface is relatively standardized; the independent business entity is a link that has an independent factor capacity and a small boundary of economies of scale, or is a combination of multiple links, and the platform enterprise is a combination of businesses that are complementary to the independent business entity and have a large boundary of economies of scale.

11. The computer readable storage medium according to claim 10, wherein the boundary of economies of scale is a critical point with highest economic effectiveness per unit input, and the boundary of economies of scope is a critical point with highest economic effectiveness per unit input in a business scope.

12. The computer readable storage medium according to claim 10, wherein a magnitude of the boundary of economies of scale of the platform enterprise is greater than a magnitude of the boundary of economies of scale of the independent business entity.
